(19) United States
(12) Patent Application Publication
(10) Pub. No.: US 2021/0011495 A1
(43) Pub. Date: Jan. 14, 2021

(54) MOVING BODY GUIDANCE APPARATUS, MOVING BODY GUIDANCE METHOD, AND COMPUTER-READABLE RECORDING MEDIUM

(71) Applicant: NEC CORPORATION, Tokyo (JP)

(72) Inventor: Tetsuo INOSHITA, Tokyo (JP)

(73) Assignee: NEC CORPORATION, Tokyo (JP)

(21) Appl. No.: 16/979,915

(22) PCT Filed: Mar. 13, 2018
(86) PCT No.: PCT/JP2018/009826

§ 371 Date: Sep. 11, 2020

(51) Int. Cl. G05D 1/12; G05D 1/00; G05D 1/06; B64C 39/02

(52) U.S. Cl. CPC G05D 1/12; G05D 1/0094; G05D 1/0676; B64C 2201/146; B64C 2201/18; B64C 2201/127; B64C 39/024

(57) ABSTRACT

Provided are a moving body guidance apparatus, a moving body guidance method and a computer-readable recording medium that are for accurately guiding a moving body to a target site. A moving body guidance apparatus 1 has a detection unit 2 that detects a feature of a target member 30 from an image captured by an image capturing unit 23 mounted on a moving body 20, the feature changing according to a measurement distance indicating the distance between the moving body 20 and the target member 30, and a control unit 3 that performs control for guiding the moving body 20 to the target site 31 where the target member 30 is installed, based on the detected feature.

### TECHNICAL FIELD

The present invention relates to a moving body guidance apparatus and a moving body guidance method that perform control for guiding a moving body, and further relates to a computer-readable recording medium that includes a program recorded thereon for realizing the apparatus and method.

### BACKGROUND ART

Unmanned aircraft can be effectively utilized in disaster and security support and the like, but since there are various flight regulations on unmanned aircraft, securing a landing site is difficult. In particular, securing a landing site for unmanned aircraft is difficult in places such as high-density residential areas.

In view of this, in recent years, landing of unmanned aircraft automatically at a landing site has been implemented, utilizing GPS (Global Positioning System) or a target installed at the landing site.

As related technology, technologies have been disclosed that involve capturing a target installed at a landing site using an image capturing apparatus mounted on an unmanned aircraft, computing the positional relationship between the moving body and the target, based on the image of the captured target, and automatically landing the unmanned aircraft at the landing site using the computation result. Also, the target that is used in Patent Document 1 has an outer figure arranged on the outermost side and a plurality of similar figures of different sizes that are smaller than the outer figure and similar in shape to the outer figure. Also, the similar figures are configured to be arranged inside the outer figure or other similar figures in decreasing order of size. Refer to Patent Document 1, for example.

### LIST OF RELATED ART DOCUMENTS

### Patent Document

Patent Document 1: Japanese Patent Laid-Open Publication No. 2012-071645

### SUMMARY OF INVENTION

### Technical Problems

However, in Patent Document 1, the target is blurrily captured in an image captured from a high altitude, in the case of landing an unmanned aircraft from a high altitude. Thus, in the case of not being able to detect the target, the positional relationship between the unmanned aircraft and the target cannot be computed, based on the image of the captured target. Accordingly, in such cases, the unmanned aircraft cannot be automatically landed at the landing site using the computation result.

An example object of the present invention is to provide a moving body guidance apparatus, a moving body guidance method and a computer-readable recording medium including a moving body guidance program recorded thereon that solve the above problems and perform control for accurately guiding a moving body to a target site.

### Solution to the Problems

A moving body guidance apparatus according to an example aspect of the present invention includes:

a detection unit configured to detect a feature of a target member from an image captured by an image capturing apparatus mounted on a moving body, the feature changing according to a measurement distance indicating a distance between the moving body and the target member; and

a control unit configured to perform control for guiding the moving body to a target site where the target member is installed, based on the detected feature.

Also, a moving body guidance method according to an example aspect of the present invention includes:

(a) a step of detecting a feature of a target member from an image captured by an image capturing apparatus mounted on a moving body, the feature changing according to a measurement distance indicating a distance between the moving body and the target member; and

(b) a step of performing control for guiding the moving body to a target site where the target member is installed, based on the detected feature.

Furthermore, a computer-readable recording medium according to an example aspect of the present invention includes a moving body guidance program recorded thereon, the program including instructions that cause a computer to carry out:

(a) a step of detecting a feature of a target member from an image captured by an image capturing apparatus mounted on a moving body, the feature changing according to a measurement distance indicating a distance between the moving body and the target member; and

(b) a step of performing control for guiding the moving body to a target site where the target member is installed, based on the detected feature.

### Advantageous Effects of the Invention

As described above, according to the present invention, control for accurately guiding a moving body to a target site can be performed.

### BRIEF DESCRIPTION OF THE DRAWINGS

FIG. 1 is a diagram showing an example of a moving body guidance apparatus.

FIG. 2 is a diagram showing an example of a system having a moving body guidance apparatus.

FIG. 3 is a diagram showing the relationship between a moving body and a target member.

FIG. 4 is a diagram showing an example of the target member.

FIG. 5 is a diagram showing images captured of the target member according to the measurement distance.

FIG. 6 is a diagram showing the relationship between the moving body and the target member.

FIG. 7 is a diagram showing an example of operations of the moving body guidance apparatus.

FIG. 8 is a diagram showing an example of detailed operations of the moving body guidance apparatus.

FIG. 9 is a diagram showing an example of a data structure of feature detection information.

FIG. 10 is a diagram showing an example of operations of the moving body guidance apparatus in a variation.

FIG. 11 is a diagram showing the relationship between the moving body and the target member.

FIG. 12 is a diagram showing an example of a computer that realizes the moving body guidance apparatus.

### EXAMPLE EMBODIMENTS

As described above, various flight regulations apply to unmanned aircraft, thus making it is difficult to secure a landing site for unmanned aircraft in places such as high-density residential areas. In view of this, utilization of locations such as the roof of emergency vehicles as a landing site for unmanned aircraft has been proposed. However, even a skilled operator would have difficulty guiding and landing an unmanned aircraft in a small area such as the roof of an emergency vehicle. Thus, a method of performing control for accurately guiding an unmanned aircraft to a small landing site and landing the unmanned aircraft is called for.

### Example Embodiment

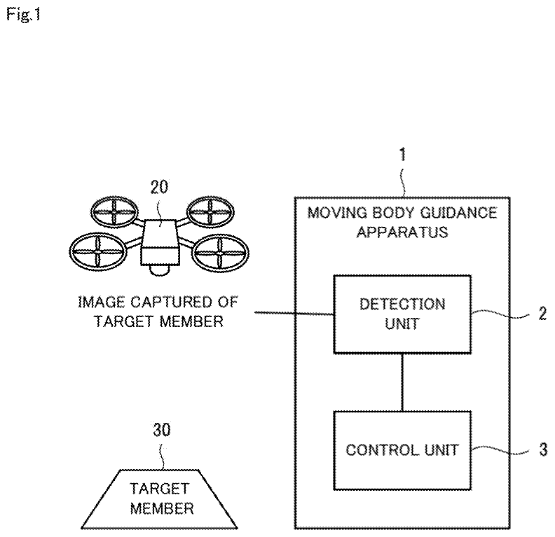

Hereinafter, a moving body guidance apparatus, a moving body guidance method and a computer-readable recording medium including a moving body guidance program recorded thereon in an example embodiment of the present invention will be described, with reference to FIGS. 1 to 6.

Note that, in the subsequent description of the example embodiment, a method of performing control for accurately guiding an unmanned aircraft to a landing site will be described as an example, but the moving body that is subjected to guidance control is not limited to an unmanned aircraft, and the moving body may be a manned airplane, a submarine or a spacecraft, for example.

[Apparatus Configuration]

Initially, the configuration of a moving body guidance apparatus in the example embodiment will be described using FIG. 1. FIG. 1 is a diagram showing an example of a moving body guidance apparatus 1.

The moving body guidance apparatus 1 in the example embodiment shown in FIG. 1 is an apparatus for performing control for accurately guiding a moving body 20 to an landing site (henceforth, target site), utilizing a target (henceforth, target member) installed at the target site. The moving body guidance apparatus 1 has a detection unit 2 and a control unit 3.

The detection unit 2 detects, from an image captured by an image capturing apparatus mounted on the moving body 20, features of a target member 30 that change according to a measurement distance indicating the distance between the moving body 20 and the target member 30. The control unit 3 performs control for guiding the moving body 20 to a target site where the target member 30 is installed, based on the detected features.

In this way, in the example embodiment, the moving body guidance apparatus 1 detects features of the target member 30 that change according to the measurement distance, thus enabling instances where the target member 30 captured in an image cannot be detected to be suppressed. For example, in the case of guiding the moving body 20 to a target site from a distant position, even when the target member 30 is blurrily captured in a captured image, the blurrily captured target member 30 is detected as a feature, thus preventing the target member 30 captured in an image from not being detected. Also, even in the case where, for example, the moving body 20 approaches the target member 30 and an entirety of the target member 30 is not captured in the image, the moving body guidance apparatus 1 detects features of the target member 30 that change according to the measurement distance, thus preventing the target member 30 captured in the image from not being detected. That is, since the moving body guidance apparatus 1 is able to detect the target member 30 according to the measurement distance, control for accurately guiding the moving body 20 to the target site where the target member 30 is installed can be performed.

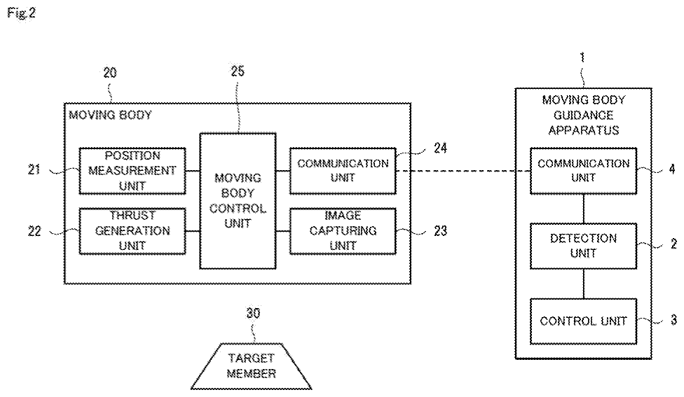

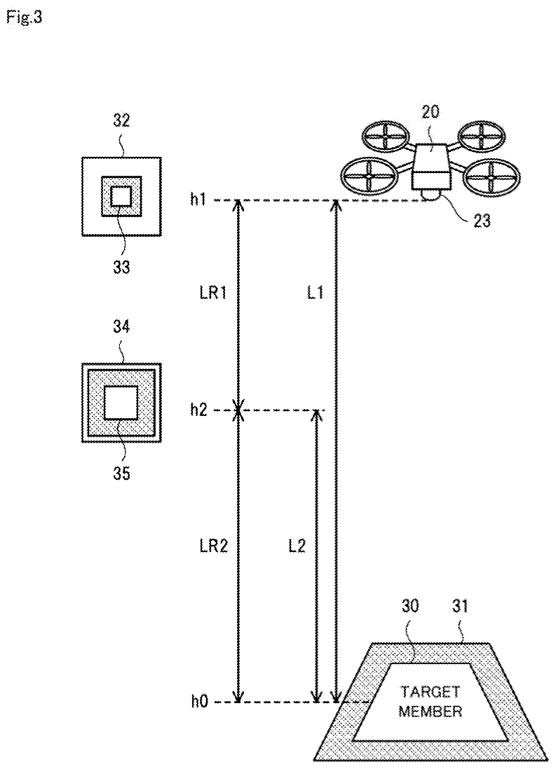

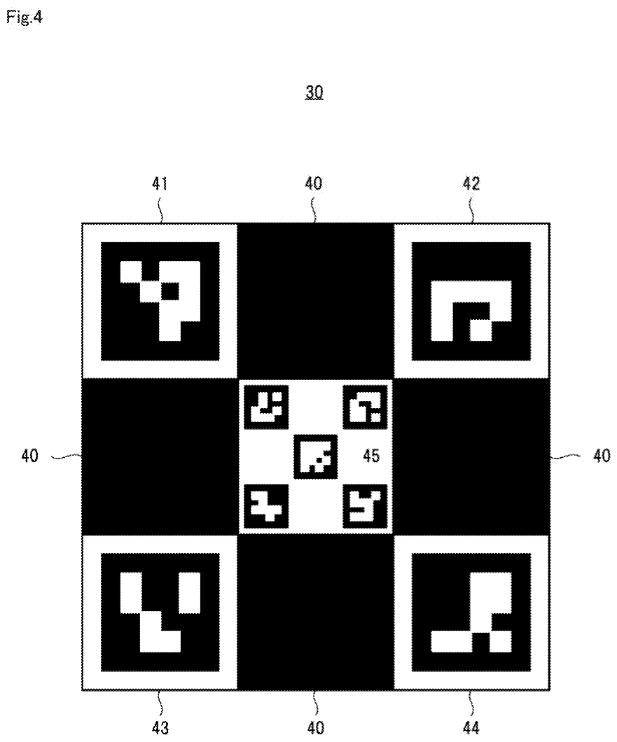

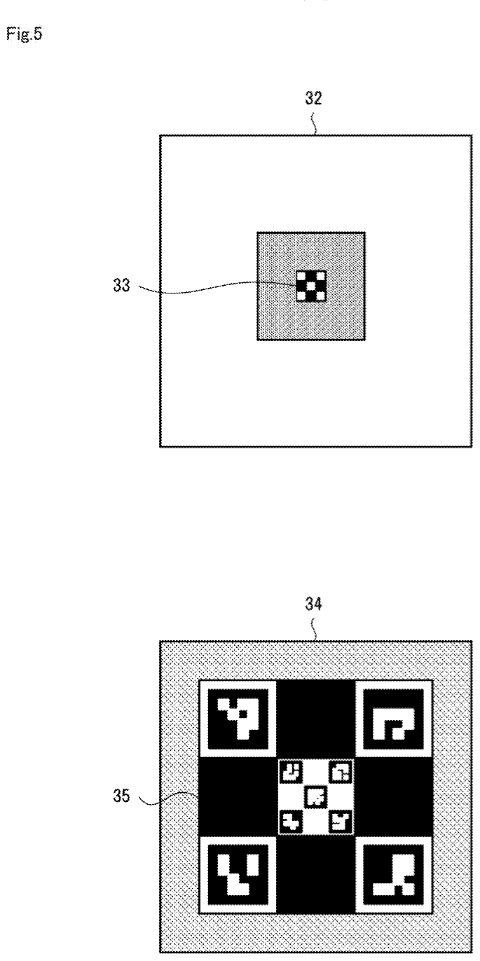

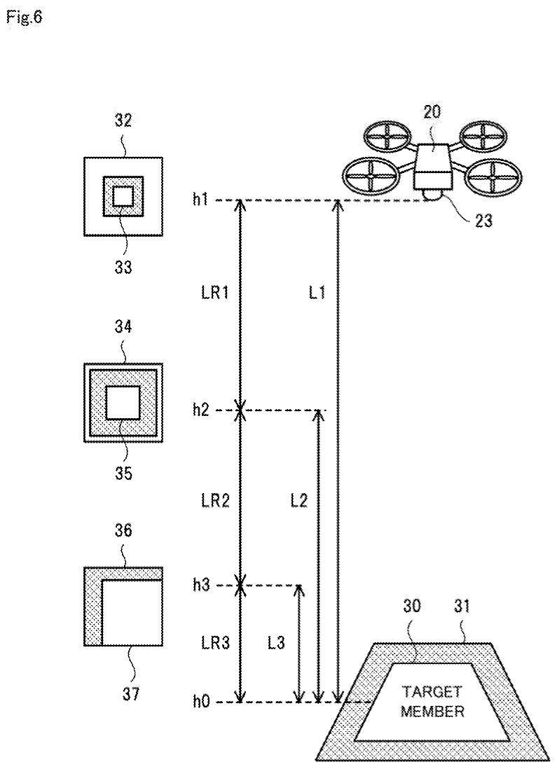

Next, the configuration of the moving body guidance apparatus 1 in the example embodiment will be more specifically described using FIGS. 2 to 6 in addition to FIG. 1. FIG. 2 is a diagram showing an example of a system having the moving body guidance apparatus. FIG. 3 is a diagram showing the relationship between the moving body and the target member. FIG. 4 is a diagram showing an example of the target member. FIG. 5 is a diagram showing images captured of the target member according to the measurement distance. FIG. 6 is a diagram showing the relationship between the moving body and the target member.

As shown in FIG. 2, in the example embodiment, the system having the moving body guidance apparatus 1 has the moving body guidance apparatus 1, the moving body 20, and the target member 30. Also, as shown in FIG. 2, in the example embodiment, the moving body guidance apparatus 1, in the example embodiment, is installed outside the moving body 20, and communicates with the moving body 20. The moving body guidance apparatus 1 thus has a communication unit 4, in addition to the abovementioned detection unit 2 and control unit 3. Note that the detection unit 2, the control unit 3 and the communication unit 4 will be described in detail later.

The moving body 20 has a position measurement unit 21, a thrust generation unit 22, an image capturing unit (image capturing apparatus) 23, a communication unit 24, and a moving body control unit 25. Note that the position measurement unit 21, the thrust generation unit 22, the image capturing unit (image capturing apparatus) 23, the communication unit 24 and the moving body control unit 25 will be described in detail later.

The target member 30 is installed at the target site where the moving body 20 will land. Also, the target member 30 is formed from a plurality of feature members. Note that the feature members will be described in detail later.

The moving body guidance apparatus 1 will now be described in detail.

The detection unit 2, in the case where the measurement distance is a distance L1 (first distance), as shown in FIG. 3, detects features (first features) of the target member 30 at the distance L1 from an image 32 (first image) captured of the target member 30 at the distance L1. That is, the detection unit 2 detects features of a target member image 33 corresponding to the target member 30 captured in the image 32. Note that the distance L1 may be represented using altitude.

Also, the detection unit 2, in the case where the measurement distance is a distance L2 (second distance) that is shorter than the distance L1, detects features (second features) of the target member 30 at the distance L2 from the image 34 (second image) captured of the target member 30 at the distance L2. That is, the detection unit 2 detects features of a target member image 35 corresponding to the target member 30 captured in the image 34 and captured more sharply than the target member image 33. Note that the distance L2 may be represented using altitude.

The distance L1 is given as the distance from a position h0 where the target member 30 is installed to a position h1. Also, the position h1 is given as a range from the highest position at which the detection unit 2 is able to detect features of the target member 30 from captured images to a position higher than a position h2. The distance L2 indicates a distance from the position h0 where the target member 30 is installed to the position h2 of the moving body 20. Also, the position h2 is given as a position that is included in the range from a position lower than the position h1 to the position h0.

Next, features of the target member 30 (target member image) captured in images that depend on the measurement distance will be described in detail. With a target member image corresponding to the target member 30 captured in an image, the shape, color and pattern of the target member image change due to the number of pixels forming the captured image or the resolution of the image capturing unit 23.

Also, in the case where the measurement distance is long, the range of the image 32 occupied by the target member image 33 (occupied range) decreases, as shown in FIG. 3. In contrast, in the case where the measurement distance is short, the range of the image 34 occupied by the target member image 35 increases, as shown in FIG. 3. This indicates that the number of pixels required in order to represent the target member image changes according to the measurement distance.

That is, since the number of pixels required in order to represent the target member image decreases in the case where the measurement distance is long (in the case where the altitude is high), the target member image 33 shown in FIG. 3 is blurrily captured. In contrast, since the number of pixels required in order to represent the target member image increases in the case where the measurement distance is short (in the case where the altitude is low), the target member image 35 is captured more sharply than the target member image 33.

In view of this, in the example embodiment, the shape, color and pattern of the target member image, the number of pixels (or area) forming the target member image, the occupied range, and the like that change according to the measurement distance are taken as features of the target member image. Note that at least one of the shape, color, pattern, area and occupied range of the target member image or a combination thereof may be used as features of the target member image.

Next, a method of detecting features of the target member (features of the target member image) captured in an image that depends on the measurement distance will be described in detail.

First, the abovementioned features of the target member image are detected from target member images corresponding to the target member 30 captured in advance while changing the measurement distance, and the detected features are stored in association with distances (distance ranges) between the moving body 20 and the target member 30 as feature detection information in a storage unit (not shown) that is provided in the moving body guidance apparatus 1. Also, in the case of performing detection using pattern matching or the like, the target member images corresponding to the target member 30 captured in advance while changing the measurement distance are taken as template images, and the template images are stored in association with distance ranges as feature detection information in the storage unit. Note that the storage unit may be provided inside the moving body guidance apparatus 1 or the detection unit 2, or may be provided outside the moving body guidance apparatus 1.

Next, the detection unit 2 acquires a measurement distance and an image from the moving body 20, and detects the target member image from the acquired image, based on the acquired measurement distance and the feature detection information.

For example, the target member 30 is assumed to be formed from a plurality of feature members 40, 41, 42, 43, 44 and 45, as shown in FIG. 4. That is, the target member 30 is formed with the feature member 45 arranged in the middle of the target member 30, and the feature members 41, 42, 43 and 44 arranged in the four corners of the target member 30. Also, the target member 30 is formed with the feature member 40 arranged between the feature member 41 and the feature members 42, between the feature member 42 and the feature members 44, between the feature member 43 and the feature members 44, and between the feature member 43 and the feature member 41. Also, the feature member 40 is a black rectangular shape and the feature members 41 to 45 are rectangular shapes having a black and white pattern.

Also, the feature members 41 to 45 shown in FIG. 4 are formed such that, in the image 32 captured at the distance L1 as shown in FIG. 5, the parts of the target member image 33 shown in FIG. 5 that correspond to the feature members 41 to 45 are blurry white images, due to the influence of the resolution of the image capturing unit 23. Also, the feature member 40 shown in FIG. 4 is formed such that the parts of the target member image 33 corresponding to the feature member 40 retain their black color, even in the image 32 captured at the distance L1 as shown in FIG. 5.

In contrast, the feature members 41 to 45 shown in FIG. 4 are formed such that, in the image 34 captured at the distance L2 as shown in FIG. 5, the parts of the target member image 35 shown in FIG. 5 that correspond to the feature members 41 to 45 shown in FIG. 4 are captured more sharply than the target member image 33, using the required number of pixels. Also, the feature member 40 shown in FIG. 4 is formed such that the parts of the target member image 35 corresponding to the feature member 40 retain their black color, even in the image 34 captured at the distance L2 as shown in FIG. 5. Note that the target member is not limited to the target member 30 shown in FIG. 4.

Specifically, the detection unit 2, in the case where the measurement distance is the distance L1, detects features of the target member image 33 which is formed by the plurality of feature members 40 to 45 from the image 32 captured at the distance L1. In other words, the detection unit 2, upon acquiring the distance L1 and the image 32 captured of the target member 30 shown in FIG. 4 captured at the distance L1 from the moving body 20, refers to the feature detection information using the acquired distance L1, and acquires features associated with the distance L1.

Next, the detection unit 2 detects the target member image 33 in the image 32, using the acquired features associated with the distance L1. For example, the detection unit 2 uses at least one of the template image and the shape, color, pattern, area and occupied range of the target member image that are associated with the distance L1 or a combination thereof to detect the target member image 33 that matches these features from the image 32.

Also, the detection unit 2, in the case where the measurement distance is the distance L2, detects features of the target member image 35 which is formed by the plurality of feature members 40 to 45 from the image 34 captured at the distance L2. In other words, the detection unit 2, upon acquiring the distance L2 and the image 34 captured of the target member 30 shown in FIG. 4 captured at the distance L2 from the moving body 20, refers to the feature detection information using the acquired distance L2, and acquires features associated with the distance L2.

Next, the detection unit 2 detects the target member image 35 in the image 34, using the acquired features associated with the distance L2. For example, the detection unit 2 uses at least one of the template image and the shape, color, pattern, area and occupied range of the target member image that are associated with the distance L2 or a combination thereof to detect the target member image 35 that matches these features from the image 34.

Next, the control unit 3, upon detecting the features of the detected target member image 33 or the features of the detected target member image 35, generates control information for performing guidance control of the moving body 20. This control information is transmitted to the moving body 20 via the communication unit 4. Also, the control information is information for controlling the thrust generation unit 22 that is provided in the moving body 20 and will be described later.

For example, in the case where the target member image 33 is detected, the control unit 3 generates control information for moving the moving body 20 to the position h2 shown in FIG. 3 or below. Also, in the case where the target member image 35 is detected, the control unit 3 generates control information for moving the moving body 20 to the position h0 shown in FIG. 3.

Furthermore, the detection unit 2 may, in the case where the measurement distance is a distance L3 (third distance) that is shorter than the distance L2, as shown in FIG. 6, detect features (third features) from one of the feature members or a portion of the feature members included in an image 36 (third image) captured of the target member 30 at the distance L3. Note that the distance L3 may be represented using altitude.

The distance L3 indicates the distance from the position h0 where the target member 30 is installed to the position h3 of the moving body 20. Also, the position h3 is assumed to be a position that is included in a range from a position lower than the position h2, that is, a position at which one of the feature members or a portion of the feature members is captured in an image 37 captured by the detection unit 2, to the position h0.

The detection method will be described in detail, using the feature members 40 to 45 shown in FIG. 4. In the case where one of the feature members 41 to 45 is captured in the target member image 37, the detection unit 2 detects the features of each of the feature members 41 to 45 from the target member image 37. The detection unit 2 also detects the features of each of the feature members 41 to 45 from the target member image 37, in the case where a portion of the feature members 41 to 45 is captured in the target member image 37.

Also, the features of the feature members 41 to 45 are detected in advance, and the detected features are stored in association with the distance L3 as feature detection information in the storage unit.

Next, the detection unit 2, in the case where the measurement distance is the distance L3, detects the target member image 37 from the acquired image 36, based on the distance L3 and the feature detection information. In other words, the detection unit 2, upon acquiring the distance L3 and the image 36 captured of the target member 30 shown in FIG. 4 captured at the distance L3 from the moving body 20, refers to the feature detection information using the acquired distance L3, and acquires features associated with the distance L3.

Next, the detection unit 2 detects the target member image 37 in the image 36, using the acquired features associated with the distance L3. For example, the detection unit 2 uses at least one of the template image and the shape, color, pattern, area and occupied range of the target member image that are associated with the distance L3 or a combination thereof to detect the object member image 37 matching these features from the image 36.

Next, the control unit 3, upon detecting the features of the detected target member image 37, generates control information for performing guidance control of the moving body 20. For example, in the case where the target member image 37 is detected, the control unit 3 generates control information for moving the moving body 20 to the position h0 shown in FIG. 6.

The communication unit 4 receives a signal including the measurement distance, image and the like transmitted from the moving body 20, or transmits a signal including the control information and the like to the moving body 20, between the moving body guidance apparatus 1 and the moving body 20. The communication unit 4 is realized by a communication device for wireless communication, for example.

The moving body 20 will now be described in detail.

In the case where the moving body 20 is a so-called drone, such as multicopter having a plurality of rotors, the moving body 20, as shown in FIG. 2, has the position measurement unit 21, the thrust generation unit 22, the image capturing unit (image capturing apparatus) 23, the communication unit 24, and the moving body control unit 25.

The position measurement unit 21 measures the current position (latitude and longitude) and altitude (measurement distance) of the moving body 20. The position measurement unit 21 receives a GPS (Global Positioning System) signal from a satellite, and measures the current position and altitude, based on the received GPS signal, for example. The thrust generation unit 22 has a propeller that generates thrust and an electric motor coupled to the propeller. Also, the parts of the thrust generation unit 22 are controlled by the moving body control unit 25 based on the control information.

The image capturing unit 23 is, for example, a video camera or a digital camera that captures the target member 30.

The communication unit 24 receives a signal that includes the control information and the like that is transmitted from the moving body guidance apparatus 1 or transmits a signal including the measurement distance, image and the like that are to be transmitted to the moving body guidance apparatus 1, between the moving body guidance apparatus 1 and the moving body 20. The communication unit 24 is, for example, realized by a communication device for wireless communication.

The moving body control unit 25 calculates the speed of the moving body 20, based on the current position and measurement distance measured by the position measurement unit 21. Also, the moving body control unit 25 transmits the calculated speed, the current position and measurement distance and the image to the moving body guidance apparatus 1 as state information, via the communication unit 24. Furthermore, the moving body control unit 25 controls the speed, measurement distance and direction of travel of the moving body 20, by adjusting the thrust of the thrust generation unit 22.

Such a moving body 20 is, for example, able to fly along a set route while checking the current location. The moving body 20 is also able to fly, according to instructions from the moving body guidance apparatus 1. Furthermore, the moving body 20 has a function of automatically returning to a target site stored in advance where the target member 30 is installed, even in cases such as where instructions from the moving body guidance apparatus 1 stop being received, the moving body 20 malfunctions, or the remaining capacity of the battery (not shown) that is mounted in the moving body 20 runs low.

[Apparatus Operations]

The moving body guidance method in the example embodiment is implemented by operating the moving body guidance apparatus 1 in the example embodiment shown in FIGS. 1 and 2. Description of the moving body guidance method in the example embodiment will thus be given by describing the operations of the moving body guidance apparatus 1, taking FIGS. 1 to 6 into consideration as appropriate.

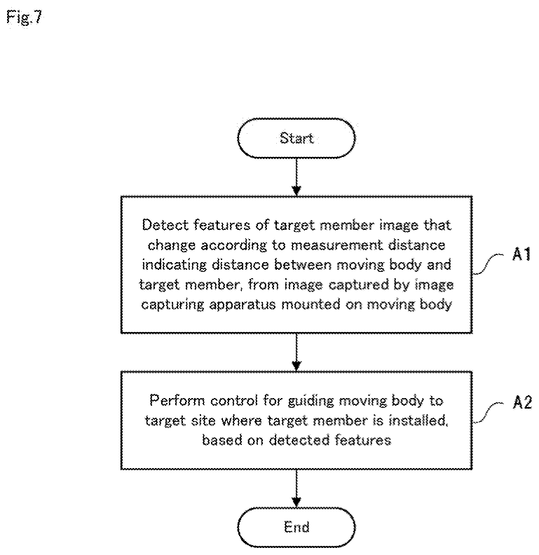

First, the overall operations of the moving body guidance apparatus 1 will be described using FIG. 7. FIG. 7 is a diagram showing an example of the operations of the moving body guidance apparatus.

As shown in FIG. 7, the moving body guidance apparatus 1 detects, from an image captured by the image capturing unit 23 mounted on the moving body 20, features of the target member 30 that change according to the measurement distance indicating the distance between the moving body 20 and the target member 30 (step A1). Next, the moving body guidance apparatus 1 performs control for guiding the moving body 20 to the target site 31 where the target member 30 is installed, based on the detected features (step A2).

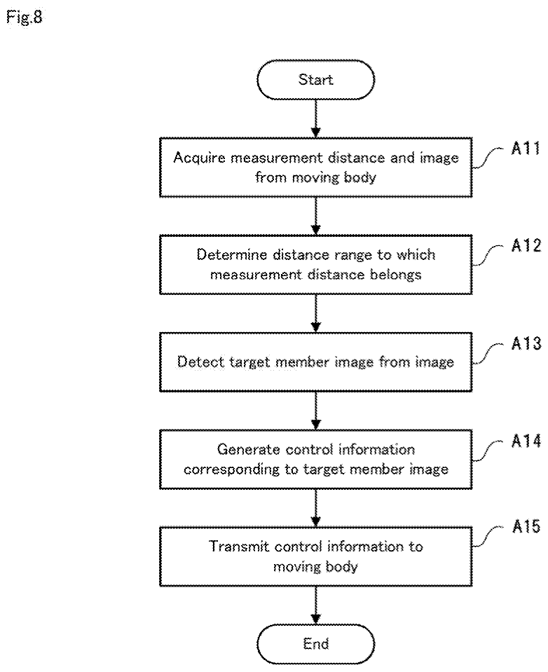

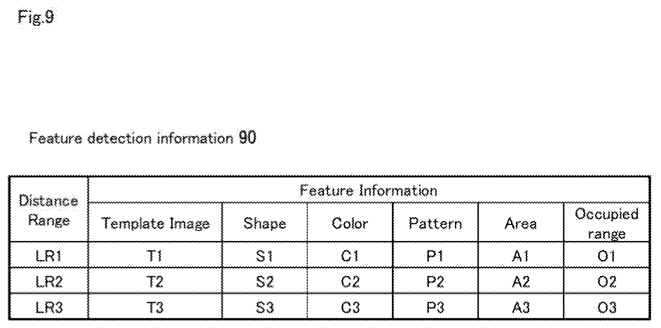

Next, the processing (steps A1, A2) in the detection unit 2 and the control unit 3 shown in FIGS. 1 and 2 will be described in detail using FIGS. 8 and 9. FIG. 8 is a diagram showing an example of detailed operations of the moving body guidance apparatus.

In step A11, the detection unit 2 acquires the measurement distance and the image captured by the image capturing unit 23 from the moving body 20. Step A11 will now be described in detail. First, the moving body control unit 25 that is mounted in the moving body 20 acquires the measurement distance measured by the position measurement unit 21 and the image captured by the image capturing unit 23, and transmits information including the measurement distance and the image to the moving body guidance apparatus 1, via the communication unit 24. In the moving body guidance apparatus 1, the communication unit 4 receives the information including the measurement distance and image, and the detection unit 2 acquires the received measurement distance and image.

In step A12, the detection unit 2 determines the distance range to which the acquired measurement distance belongs. Step A12 will now be specifically described. The detection unit 2 determines whether the acquired measurement distance belongs to a distance range LR1 shown in FIGS. 3 and 6 that is at or below the position h1 and higher than the position h2, or belongs to a distance range LR2 shown in FIG. 6 that is at or below the position h2 and higher than the position h3, or belongs to a distance range LR3 that is at or below the position h3.

In step A13, the detection unit 2 detects a target member image from the acquired image. Step A13 will now be specifically described. First, the detection unit 2 refers to the feature detection information in which distance ranges and feature information are associated, using the measurement distance, and acquires feature information. Next, the detection unit 2 performs processing for detecting a region that matches the feature information from the image, using the acquired feature information, and detects the target member image. For example, pattern matching or the like is performed, and the target member image is detected from the acquired image.

Pattern matching is performed using the template image associated with the distance range. Furthermore, in the case of improving the detection accuracy, at least one of the shape, color, pattern, area and occupied range of the target member image or a combination thereof may be used.

FIG. 9 is a diagram showing an example of the data structure of the feature detection information. In FIG. 9, feature information is respectively associated with distance ranges in the feature detection information 90. Distance Range, for example, has information “LR1”, “LR2” and “LR3” indicating the abovementioned distance ranges. Feature Information, for example, has information “T1”,“T2” and “T3” indicating template images, information “S1”, “S2” and “S3” indicating shapes, information “C1”, “C2” and “C3” indicating colors, information “P1”, “P2” and “P3” indicating patterns, information “A1”, “A2” and “A3” indicating areas, and information “O1”, “O2” and “O3” indicating occupied ranges.

Next, upon the detection unit 2 detecting the target member 30 from the image in step A13, the detection unit 2 sends, to the control unit 3, an instruction to generate control information for performing guidance control of the moving body 20 that depends on the measurement distance.

In step A14, the control unit 3 generates control information corresponding to the target member image. Step A14 will now be specifically described. The control unit 3, upon the instruction to generate control information being acquired from the detection unit 2, generates control information for moving the moving body 20 from the current position to the target site 31 where the target member 30 is installed. Or else, the control unit 3 generates control information for moving the moving body 20 from the current position to a predetermined position. Regarding the predetermined position, in the case where the moving body 20 is at the position of the position h1, for example, it is conceivable to set the position h2, the position h3 or the position h0 as the predetermined position. Alternatively, in the case where the moving body 20 is at the position of the position h2, it is conceivable to set the position h3 or the position h0 as the predetermined position. Furthermore, in the case where the moving body 20 is at the position of the position h3, it is conceivable to set the position h3 or the position h0 as the predetermined position.

In step A15, the control unit 3 transmits the control information to the moving body 20. Step A15 will now be specifically described. The control unit 3 transmits information including the control information to the moving body 20, via the communication unit 4. Upon the control information being received via the communication unit 24 mounted in the moving body 20, the moving body control unit 25 controls the thrust generation unit 22, based on the control information.

(Variation)

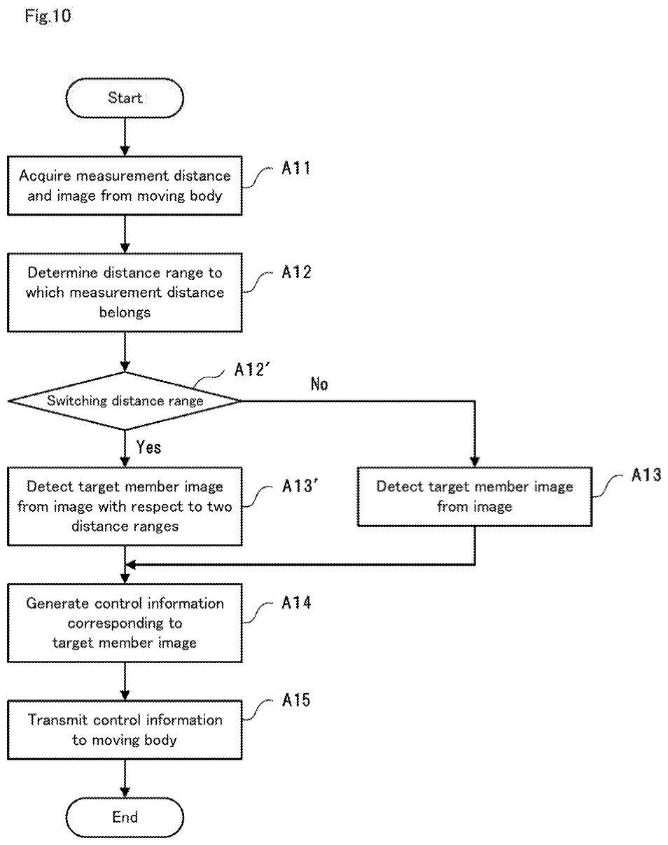

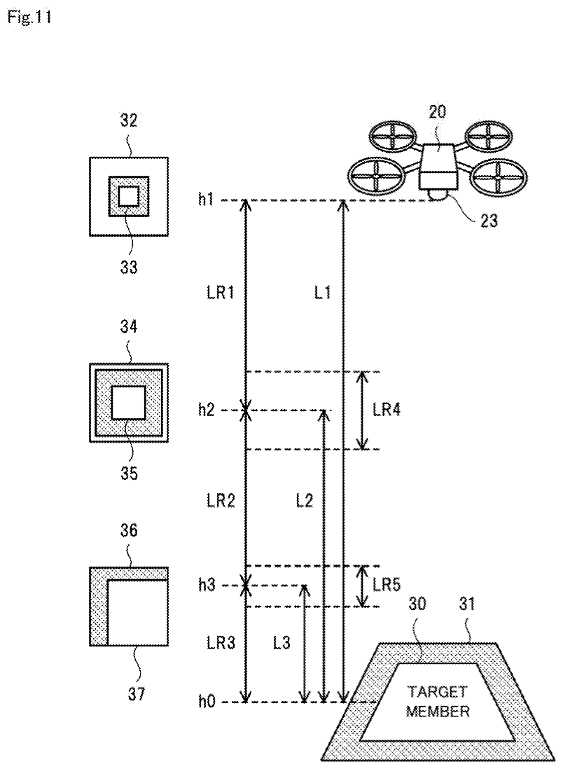

A variation of the example embodiment will be described, taking FIGS. 1, 2, 8, 10 and 11 into consideration as appropriate. FIG. 10 is a diagram showing an example of operations of the moving body guidance apparatus in the variation. FIG. 11 is a diagram showing the relationship between the moving body and the target member. First, the detection unit 2 included in the moving body guidance apparatus 1 shown in FIG. 1 or 2 executes respective processing for detecting features corresponding to the measurement distance in parallel, and, in the case where features are detected by the respective processing for detecting features executed in parallel, selects the features detected by the processing for detecting features corresponding to the shortest measurement distance (step A12′). Next, the control unit 3 performs control for guiding the moving body 20 to the target site 31, based on the selected features (step A13′).

Next, the processing (steps A12′, A13′) in the detection unit 2 and the control unit 3 will be described in detail. In FIG. 10, after the processing of the abovementioned steps A11 and A12 has been performed, the detection unit 2, in step A12′, determines whether the measurement distance is in a switching distance range. If the measurement distance is in a switching distance range (step A12′: Yes), the detection unit 2 executes the processing of step 13′, and if the measurement distance is not in a switching distance range (step A12′: No), the detection unit 2 executes the processing of step 13.

The switching distance range is, for example, a distance range LR4 shown in FIG. 11 that includes the position h2 serving as the boundary between the abovementioned distance ranges LR1 and LR2, or a distance range LR5 shown in FIG. 11 that includes the position h3 serving as the boundary between the abovementioned distance ranges LR2 and LR3.

In the case where the moving body 20 is in the distance range LR4 or the distance range LR5, the measurement distance also varies when the moving body 20 moves back and forth between the distance range LR1 and the distance range LR2 or between the distance range LR2 and distance range LR3, due to a change in the surrounding environment such as a gust of wind. As a result, in step A12, the detection unit 2 is unable to determine which distance range the measurement distance belongs to.

In view of this, in step A13′, the detection unit 2, in the case where the measurement distance is included in the switching distance range LR4 straddling the distance ranges LR1 and LR2, executes processing for detecting features corresponding to the distance range LR1 in parallel with processing for detecting features corresponding to the distance range LR2. Or else, in step A13′, the detection unit 2, in the case where the measurement distance is included in the switching distance range LR5 straddling the distance ranges LR2 and LR3, executes processing for detecting features corresponding to the distance range LR2 in parallel with processing for detecting features corresponding to the distance range LR3.

Thereafter, in the case where a target member image is detected in both of the respective processing executed in parallel for detecting features in step A13′, the detection unit 2 uses the target member detected by the processing for detecting features corresponding to the distance range whose height is lower. This is because the image that is used in processing is captured more sharply with the processing for detecting features corresponding to the distance range whose height is lower. Next, in step A13′, the detection unit 2, upon detecting the target member from the image, sends an instruction to generate control information to the control unit 3.

### Effects of the Example Embodiment

As mentioned above, according to the example embodiment and the variation, the moving body guidance apparatus 1 detects features of the target member image according to the measurement distance, and is thus able to suppress instances where the target member image captured in an image cannot be detected. As a result, the moving body guidance apparatus 1 is able to perform control for accurately guiding the moving body 20 to the target site 31 where the target member 30 is installed.

Also, by utilizing the moving body guidance apparatus 1 shown in the example embodiment and the variation, the moving body 20 can, furthermore, be guided to the target site 31 more accurately than in the case where GPS is used, without using GPS or the like in the guidance control to the target site 31. In particular, such a configuration is effective when performing control for accurately guiding the moving body 20 to a small target site 31.

Note that the functions of the abovementioned detection unit 2 and control unit 3 may be provided in the moving body control unit 25 included in the moving body 20.

[Program]

A moving body guidance program in the example embodiment of the present invention need only be a program that causes a computer to execute the steps shown in FIGS. 7, 8 and 10. The moving body guidance apparatus 1 and the moving body guidance method in the example embodiment can be realized, by this program being installed on a computer and executed. In this case, a processor of the computer performs processing while functioning as the detection unit 2 and the control unit 3.

Also, the program in the example embodiment may be executed by a computer system built from a plurality of computers. In this case, the computers may each function as one of the detection unit 2 and the control unit 3.

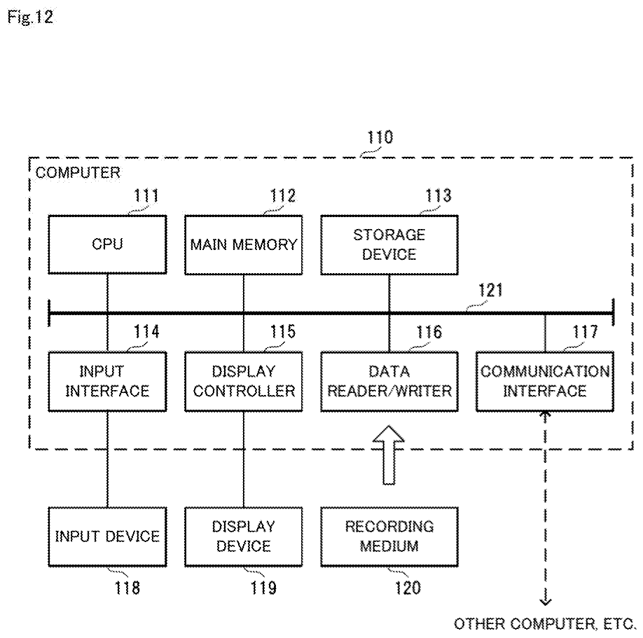

Here, a computer that realizes the moving body guidance apparatus 1 by executing a program of the example embodiment will be described using FIG. 12. FIG. 12 is a block diagram showing an example of a computer that realizes the moving body guidance apparatus 1 in the example embodiment of the present invention.

As shown in FIG. 12, a computer 110 includes a CPU (Central Processing Unit) 111, a main memory 112, a storage device 113, an input interface 114, a display controller 115, a data reader/writer 116, and a communication interface 117. These constituent elements are connected to each other in a manner that enables data communication, via a bus 121. Note that the computer 110 may have a GPU (Graphics Processing Unit), an FPGA (Field-Programmable Gate Array) or the like, in addition to the CPU 111 or instead of the CPU 111.

The CPU 111 implements various computational operations, by extracting programs (code) in the example embodiment that are stored in the storage device 113 to the main memory 112, and executing these programs in predetermined order. The main memory 112, typically, is a volatile storage device such as a DRAM (Dynamic Random Access Memory). Also, programs in the example embodiment are provided in a state of being stored in a computer-readable recording medium 120. Note that programs in the example embodiment may be distributed over the Internet connected via the communication interface 117.

Also, a semiconductor storage device such as a flash memory is given as a specific example of the storage device 113, other than a hard disk drive. The input interface 114 mediates data transmission between the CPU 111 and input devices 118 such as a keyboard and a mouse. The display controller 115 is connected to a display device 119 and controls display on the display device 119.

The data reader/writer 116 mediates data transmission between the CPU 111 and the recording medium 120, and executes readout of programs from the recording medium 120 and writing of processing results of the computer 110 to the recording medium 120. The communication interface 117 mediates data transmission between the CPU 111 and other computers.

Also, a general-purpose semiconductor storage device such as a CF (Compact Flash (registered trademark)) card or an SD (Secure Digital) card, a magnetic recording medium such as a flexible disk, and an optical recording medium such as a CD-ROM (Compact Disk Read Only Memory) are given as specific examples of the recording medium 120.

Note that the moving body guidance apparatus 1 in the example embodiment is also realizable by using hardware that corresponds to the various parts, rather than by a computer on which programs are installed. Furthermore, the moving body guidance apparatus 1 may be partially realized by programs, and the remaining portion may be realized by hardware.

[Supplementary Notes]

The following supplementary notes are further disclosed in relation to the above example embodiment. Note that the example embodiment described above can be partially or wholly realized by supplementary notes 1 to 15 described below, although the present invention is not limited to the following description.

(Supplementary Note 1)

A moving body guidance apparatus including:

a detection unit configured to detect a feature of a target member from an image captured by an image capturing apparatus mounted on a moving body, the feature changing according to a measurement distance indicating a distance between the moving body and the target member; and

a control unit configured to perform control for guiding the moving body to a target site where the target member is installed, based on the detected feature.

(Supplementary Note 2)

The moving body guidance apparatus according to supplementary note 1, in which

the detection unit, in a case where the measurement distance is a first distance, detects a first feature of the target member at the first distance from a first image captured of the target member at the first distance, and, in a case where the measurement distance is a second distance shorter than the first distance, detects a second feature of the target member at the second distance from a second image captured of the target member at the second distance.

(Supplementary Note 3)

The moving body guidance apparatus according to supplementary note 2, in which

the detection unit, in the case where the measurement distance is the first distance, detects the first feature of the target member which is formed by a plurality of feature members from the first image captured at the first distance, and

the detection unit, in the case where the measurement distance is the second distance, detects the second feature of the target member formed by the plurality of feature members from the second image captured at the second distance.

(Supplementary Note 4)

The moving body guidance apparatus according to supplementary note 3, in which

the detection unit, in a case where the measurement distance is a third distance shorter than the second distance, detects a third feature from one of the feature members or a portion of the feature members included in a third image captured of the target member at the third distance.

(Supplementary Note 5)

The moving body guidance apparatus according to any one of supplementary notes 1 to 4, in which

the detection unit executes respective processing for detecting the feature corresponding to the measurement distance in parallel, and, in a case where the feature is detected in the respective processing for detecting the feature executed in parallel, selects the feature detected by the processing for detecting the feature corresponding to the measurement distance that is shortest, and

the control unit performs control for guiding the moving body to the target site, based on the selected feature.

(Supplementary Note 6)

A moving body guidance method including:

(a) a step of detecting a feature of a target member from an image captured by an image capturing apparatus mounted on a moving body, the feature changing according to a measurement distance indicating a distance between the moving body and the target member; and

(b) a step of performing control for guiding the moving body to a target site where the target member is installed, based on the detected feature.

(Supplementary Note 7)

The moving body guidance method according to supplementary note 6,

in the (a) step, in a case where the measurement distance is a first distance, a first feature of the target member at the first distance is detected from a first image captured of the target member at the first distance, and, in a case where the measurement distance is a second distance shorter than the first distance, a second feature of the target member at the second distance is detected from a second image captured of the target member at the second distance.

(Supplementary Note 8)

The moving body guidance method according to supplementary note 7, in which

in the (a) step, in the case where the measurement distance is the first distance, the first feature of the target member which is formed by a plurality of feature members is detected from the first image captured at the first distance, and

in the (a) step, in the case where the measurement distance is the second distance, the second feature of the target member formed by the plurality of feature members is detected from the second image captured at the second distance.

(Supplementary Note 9)

The moving body guidance method according to supplementary note 8, in which

in the (a) step, in a case where the measurement distance is a third distance shorter than the second distance, a third feature is detected from one of the feature members or a portion of the feature members included in a third image captured of the target member at the third distance.

(Supplementary Note 10)

The moving body guidance method according to any one of supplementary notes 6 to 9, in which

in the (a) step, respective processing for detecting the feature corresponding to the measurement distance is executed in parallel, and, in a case where the feature is detected in the respective processing for detecting the feature executed in parallel, the feature detected by the processing for detecting the feature corresponding to the measurement distance that is shortest is selected, and

in the (b) step, control for guiding the moving body to the target site is performed, based on the selected feature.

(Supplementary Note 11)

A computer-readable recording medium according to an example aspect of the present invention includes a moving body guidance program recorded thereon, the program including instructions that cause a computer to carry out:

(a) a step of detecting a feature of a target member from an image captured by an image capturing apparatus mounted on a moving body, the feature changing according to a measurement distance indicating a distance between the moving body and the target member; and

(b) a step of performing control for guiding the moving body to a target site where the target member is installed, based on the detected feature.

(Supplementary Note 12)

The computer-readable recording medium according to supplementary note 11, in which

in the (a) step, in a case where the measurement distance is a first distance, a first feature of the target member at the first distance is detected from a first image captured of the target member at the first distance, and, in a case where the measurement distance is a second distance shorter than the first distance, a second feature of the target member at the second distance is detected from a second image captured of the target member at the second distance.

(Supplementary Note 13)

The computer-readable recording medium according to supplementary note 12, in which

in the (a) step, in the case where the measurement distance is the first distance, the first feature of the target member which is formed by a plurality of feature members is detected from the first image captured at the first distance, and

in the (a) step, in the case where the measurement distance is the second distance, the second feature of the target member formed by the plurality of feature members is detected from the second image captured at the second distance.

(Supplementary Note 14)

The computer-readable recording medium according to supplementary note 13, in which

in the (a) step, in a case where the measurement distance is a third distance shorter than the second distance, a third feature is detected from one of the feature members or a portion of the feature members included in a third image captured of the target member at the third distance.

(Supplementary Note 15)

The computer-readable recording medium according to any one of supplementary notes 11 to 14, in which

in the (a) step, respective processing for detecting the feature corresponding to the measurement distance is executed in parallel, and, in a case where the feature is detected in the respective processing for detecting the feature executed in parallel, the feature detected by the processing for detecting the feature corresponding to the measurement distance that is shortest is selected, and

in the (b) step, control for guiding the moving body to the target site is performed, based on the selected feature.

Although the present invention of the present application has been described above with reference to an example embodiment, the present invention is not limited to the foregoing example embodiment. Various modifications apparent to those skilled in the art can be made to the configurations and details of the present invention of the present application within the scope of the present invention.

### INDUSTRIAL APPLICABILITY

As described above, according to the present invention, a moving body can be accurately guided to a target site. The present invention is useful in fields for guiding a moving body to a target site.

### LIST OF REFERENCE SIGNS

1 Moving body guidance apparatus

2 Detection unit

3 Control unit

4 Communication unit

20 Moving body

21 Position measurement unit

22 Thrust generation unit

23 Image capturing unit

24 Communication unit

25 Moving body control unit

30 Target member

31 Target site

32, 34, 34, 36, 38 Image

33, 35, 37 Target member image

35 Target member image

40, 41, 42, 43, 44, 45 Feature member

90 Feature detection information

110 Computer

111 CPU

112 Main memory

113 Storage device

114 Input interface

115 Display controller

116 Data reader/writer

117 Communication interface

118 Input device

119 Display device

120 Recording medium

121 Bus

What is claimed is:

1. A moving body guidance apparatus comprising:
a detection unit configured to detect a feature of a target member from an image captured by an image capturing apparatus mounted on a moving body, the feature changing according to a measurement distance indicating a distance between the moving body and the target member; and
a control unit configured to perform control for guiding the moving body to a target site where the target member is installed, based on the detected feature.

2. The moving body guidance apparatus according to claim 1, wherein
the detection unit, in a case where the measurement distance is a first distance, detects a first feature of the target member at the first distance from a first image captured of the target member at the first distance, and, in a case where the measurement distance is a second distance shorter than the first distance, detects a second feature of the target member at the second distance from a second image captured of the target member at the second distance.

3. The moving body guidance apparatus according to claim 2, wherein
the detection unit, in the case where the measurement distance is the first distance, detects the first feature of the target member which is formed by a plurality of feature members from the first image captured at the first distance, and
the detection unit, in the case where the measurement distance is the second distance, detects the second feature of the target member formed by the plurality of feature members from the second image captured at the second distance.

4. The moving body guidance apparatus according to claim 3, wherein
the detection unit, in a case where the measurement distance is a third distance shorter than the second distance, detects a third feature from one of the feature members or a portion of the feature members included in a third image captured of the target member at the third distance.

5. The moving body guidance apparatus according to claim 1, wherein
the detection unit executes respective processing for detecting the feature corresponding to the measurement distance in parallel, and, in a case where the feature is detected in the respective processing for detecting the feature executed in parallel, selects the feature detected by the processing for detecting the feature corresponding to the measurement distance that is shortest, and
the control unit performs control for guiding the moving body to the target site, based on the selected feature.

6. A moving body guidance method comprising:
detecting a feature of a target member from an image captured by an image capturing apparatus mounted on a moving body, the feature changing according to a measurement distance indicating a distance between the moving body and the target member; and
(b) performing control for guiding the moving body to a target site where the target member is installed, based on the detected feature.

7. The moving body guidance method according to claim 6, wherein
in a case where the measurement distance is a first distance, a first feature of the target member at the first distance is detected from a first image captured of the target member at the first distance, and, in a case where the measurement distance is a second distance shorter than the first distance, a second feature of the target member at the second distance is detected from a second image captured of the target member at the second distance.

8. The moving body guidance method according to claim 7, wherein
in the case where the measurement distance is the first distance, the first feature of the target member which is formed by a plurality of feature members is detected from the first image captured at the first distance, and
in the case where the measurement distance is the second distance, the second feature of the target member formed by the plurality of feature members is detected from the second image captured at the second distance.

9. The moving body guidance method according to claim 8, wherein
in a case where the measurement distance is a third distance shorter than the second distance, a third feature is detected from one of the feature members or a portion of the feature members included in a third image captured of the target member at the third distance.

10. The moving body guidance method according to claim 6, wherein
respective processing for detecting the feature corresponding to the measurement distance is executed in parallel, and, in a case where the feature is detected in the respective processing for detecting the feature executed in parallel, the feature detected by the processing for detecting the feature corresponding to the measurement distance that is shortest is selected, and
control for guiding the moving body to the target site is performed, based on the selected feature.

11. A non-transitory computer-readable recording medium that includes a moving body guidance program recorded thereon, the program including instructions that cause a computer to carry out:
detecting a feature of a target member from an image captured by an image capturing apparatus mounted on a moving body, the feature changing according to a measurement distance indicating a distance between the moving body and the target member; and
performing control for guiding the moving body to a target site where the target member is installed, based on the detected feature.

12. The non-transitory computer-readable recording medium according to claim 11, wherein
in a case where the measurement distance is a first distance, a first feature of the target member at the first distance is detected from a first image captured of the target member at the first distance, and, in a case where the measurement distance is a second distance shorter than the first distance, a second feature of the target member at the second distance is detected from a second image captured of the target member at the second distance.

13. The non-transitory computer-readable recording medium according to claim 12, wherein
in the case where the measurement distance is the first distance, the first feature of the target member which is formed by a plurality of feature members is detected from the first image captured at the first distance, and
in the case where the measurement distance is the second distance, the second feature of the target member formed by the plurality of feature members is detected from the second image captured at the second distance.

14. The non-transitory computer-readable recording medium according to claim 13, wherein
in a case where the measurement distance is a third distance shorter than the second distance, a third feature is detected from one of the feature members or a portion of the feature members included in a third image captured of the target member at the third distance.

15. The non-transitory computer-readable recording medium according to claim 11, wherein
respective processing for detecting the feature corresponding to the measurement distance is executed in parallel, and, in a case where the feature is detected in the respective processing for detecting the feature executed in parallel, the feature detected by the processing for detecting the feature corresponding to the measurement distance that is shortest is selected, and
control for guiding the moving body to the target site is performed, based on the selected feature.
